(19) United States
(12) Patent Application Publication
(10) Pub. No.: US 2009/0106163 A1
(43) Pub. Date: Apr. 23, 2009

(54) ELECTRONIC FORUM BASED ON GRAIN QUALITY

(75) Inventors: JOSEPH P. FORESMAN, CLIVE, IA (US); RANDY SCHLATTER, VAN METER, IA (US); SCOTT ERIC IVERSON, POLK CITY, IA (US); CATHERINE BLOOM, WAUKEE, IA (US); VIRGIL M. ROBINSON, URBANDALE, IA (US); WILLIAM A. BELZER, GRIMES, IA (US); RUSSELL F. SANDERS, WAUKEE, IA (US); DAN UPPENA, CLIVE, IA (US)

Correspondence Address: MCKEE, VOORHEES & SEASE, P.L.C.;ATTN: PIONEER HI-BRED, 801 GRAND AVENUE, SUITE 3200, DES MOINES, IA, 50309-2721, US

(73) Assignee: PIONEER HI-BRED INTERNATIONAL, INC., JOHNSTON, IA (US)

(21) Appl. No.: 12/253,258

(22) Filed: Oct. 17, 2008

Related U.S. Application Data
(60) Provisional application No. 60/981,331, filed on Oct. 19, 2007.

(51) Int. Cl. G06Q 30/00; G06Q 50/00

(52) U.S. Cl. 705/80; 705/26

(57) ABSTRACT

A method for providing an electronic forum for facilitating commercial transactions for grain includes collecting a grower profile for each of a plurality of growers, collecting grain bin data for the grain associated with each of the plurality of growers, determining a representation of grain quality using data comprising grain bin data, providing to a plurality of buyers access to the representation of grain quality through the electronic forum, and facilitating purchase of the grain from one or more of the plurality of growers by one or more of the plurality of buyers.

### RELATED APPLICATIONS

This application claims priority under 35 U.S.C. §119 to a provisional application, U.S. Patent Application No. 60/981,331, filed Oct. 19, 2007, hereby incorporated by reference in its entirety.

### FIELD OF THE INVENTION

The present invention relates to grain quality. More particularly, but not exclusively, the present invention relates to an electronic forum for the buying and selling of grain where buying and selling decisions may be supported by data related to grain quality.

### BACKGROUND

The grain procurement industry generally treats grain as a commodity, particularly from a grower's perspective. Yet at the same time, end users of grain such as processors or livestock producers recognize that grain having different attributes or of different quality may have significantly different value. End users typically rely on grain handlers to aggregate grain from multiple growers, including by quality. Grain handlers may receive significant revenue for such aggregation.

Under such a system, it is difficult for growers to share in the true value of the grain they produce. This problem is further compounded because growers do not necessarily even know the quality of the grain they produce, thus can not use the quality information in negotiating price. Such problems are even further compounded because end users may prefer grain having attributes associated with superior genetics, yet growers may be reluctant to use seed having superior genetics because they do not receive sufficient economic benefit for doing so.

Therefore what is needed is a vehicle to shift the grain procurement industry from commodity grain to quality grain in a manner that is compelling, quantifiable, and sustainable and in a manner that benefits growers as well as processors.

### SUMMARY

A method for providing an electronic forum for facilitating commercial transactions for grain includes collecting a grower profile for each of a plurality of growers, collecting data which includes grain bin data for the grain associated with each of the plurality of growers, determining a representation of grain quality based on the grain bin data, providing to a plurality of buyers access to the representation of grain quality through the electronic forum, and facilitating purchase of the grain from one or more of the plurality of growers by one or more of the plurality of buyers. The data may also include genetic data or environmental data.

### BRIEF DESCRIPTION OF THE DRAWINGS

FIG. 1 is a block diagram according to one aspect illustrating an electronic forum for facilitating commercial transactions for grain.

FIG. 2 is an illustration of a screen display associated with a grower profile.

FIG. 3 is an illustration of another screen display associated with a grower profile.

FIG. 4 is an illustration of a screen display associated with a grower profile.

FIG. 5 is a block diagram illustrating additional components which may be associated with a grower profile or grower signup.

FIG. 6 is a block diagram.

FIG. 7 is an illustration of a screen display showing a drying profile for grain.

### DETAILED DESCRIPTION

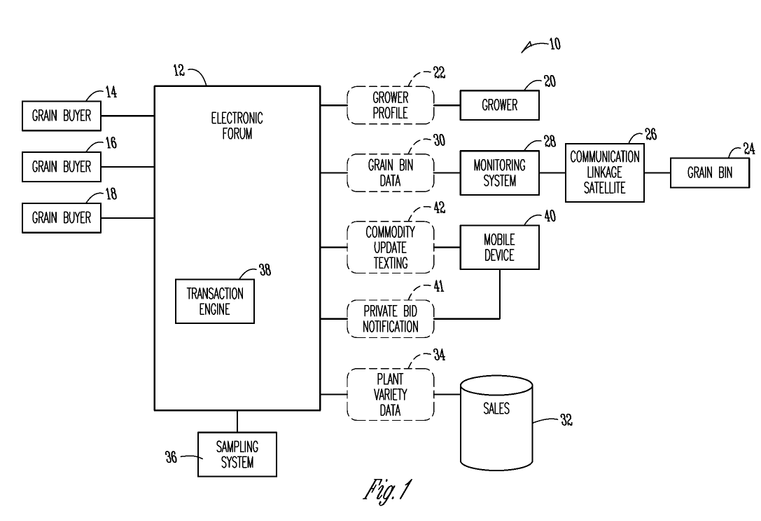

FIG. 1 is a block diagram illustrating a system 10 which includes an electronic forum 12 for facilitating commercial transactions for grain. The system 10 is grower centric in that multiple grain buyers such as grain buyers 14, 16, 18 may buy from any single grower 20. Although only a single grower 20 is shown for illustrative convenience, it is to be understood that multiple growers may use the system, and there are optionally multiple grain buyers available for each grower 20, thus the system need not limit grower choices for marketing, and as more buyers use the system, more value is provided to each grower 20.

The grower 20 provides data in the form of a grower profile 22 to the electronic forum 12. The grower profile 22 can include information such as a customer number, a farm name, a contact name, address, a primary farm grain merchandising contact (which may be the same or different from the contact name), email address, cell phone number, cell phone service provider, whether text alerts are desired or not, a selling radius which may be given in miles or km and may be used for selecting buyers, total corn acres, total grain quantity produced (for example, the total corn bushels produced where the grain is corn), the size of available storage (such as total bushels of storage available), and types of grain marketed. The grower profile 22 may also include information indicating genetic information such as plant variety type.

Other information which may form a part of a grower profile includes number of bins, bin capacities, unload efficiency (such as bu/hour) of each bin, bin description, bin location (GPS coordinates), drying efficiency (bu/hour), and quality monitors in use such as temperature and/or moisture monitors. Additional information which may form a part of a grower profile may include the expected yield for each plant variety and expected population for each plant variety. The additional information may further include GPS coordinates associated with a field where the plant variety was grown, or other location information, crop management practices employed, environmental data, or other information.

It is contemplated that at least a portion of the grower profile need not be obtained directly from the grower but may be obtained in alternative ways. For example, some of the data in the grower profile may be obtained through a sales database 32. Such information may be used to pre-populate fields of data or to otherwise simplify the process by which a grower profile is created. Information from the sales database 32 may include plant variety data 34 or other genetic data which may be used in determining grain quality.

As previously explained, a part of the grower profile may include grain bin information. It is contemplated that each grower 20 may have one or more grain bins 24. Information about each grain bin may be monitored to provide additional information about grain quality. A communications linkage 26 provides for electronically monitored grain bin data 30 to be remotely received such as by a monitoring system 26 and then the grain bin data 30 may be communicated to the electronic forum 12. One example of a grain bin monitoring device that may be used is the AgriDry Bullseye Grain Temperature/Moisture Controller (AgriDry, LLC, Edon, Ohio, USA). Information from the grain bin monitoring device can be used to predict the suitability of the grain for particular end uses. In particular, information from the grain bin monitoring device may include information such as grain moisture. It may also include information about the temperatures the grain has been exposed to during the drying and/or storage process.

A sampling system 36 may also be used at delivery points to sample grain with resulting data being communicated to the electronic forum. Data from the sampling system 36 may be used to provide feedback on the historical ability of each grower 20 to deliver grain of a particular quality. The feedback may be provided to the grower or to the buyer. One example of a grain analyzer that may be used in such a sampling system is available from FOSS (Foss, Eden Prairie, Minn., USA) and may include Ethanol Yield Potential calibration.

It is to be understood, however, that any number of means can be used to measure grain composition or other quality-related traits. Knowledge of quality leads to an understanding of the inherent value of the crop to the processor or other user of the crop. The inherent value of the crop to the processor may vary according to the specific processes used by the processor. Because of the varying value of grain to a processor, the processor is willing to pay the producer differentially based on crop quality.

For example in ethanol processing, where grain to be harvested is known to have a particularly high potential ethanol yield, an ethanol processor will know that less grain will be required which creates significant value for the ethanol processor. Of course, various types of processing operations may be performed by a processor. The processor may provide for ethanol processing, sugars processing, starch processing, beverage alcohol processing, or snack/cereal processing. In different types of processing, different characteristics for the crop may be at a premium. The processing may result in products used in food manufacturing. Of course, little processing may be required such as where the crop is used for feed in livestock production.

Depending upon the particular use for the grain, quality may be measured in different ways. Where the quality-related trait is not directly measured, predictive models may be used as are known in the art. Quality-related traits which may be determined by predictive models include, without limitation, high extractable starch (HES), high total fermentables (HTF), high available energy (HAE), amino acid content, and enzymatic content. Other examples of quality-related traits for the production of dry-grind ethanol include low stress cracks, and low occurrence of molds and diseases. Total fermentables is the sum of all starches and simple sugars that ferment in the typical dry-grind process.

It should further be understood that grain quality may also be based at least in part on genetic traits, including genetic traits that are not just simple generation traits, such as starch genotype. Genetic traits such as herbicide resistant traits or insect resistant traits may be used in determining quality. Examples of herbicide resistant traits include, without limitation, glyphosate resistance traits, sulfonylurea (SU) resistance traits, dicamba resistance traits, imidazolinone resistance traits, LIBERTYLINK traits, and other types of herbicide resistant traits. Examples of insect resistance traits include, without limitation, corn borer resistance traits, HERCULEX traits, and other types of traits which may be used in determining quality.

It should be further understood that grain quality may also be related to the environment in which the grain was produced. Thus environmental data may be taken into account in determining grain quality.

Other types of quality traits include grain footprint, variations in native enzymes, kernel shape and density, test weight, endosperm hardness, and other characteristics associated with any quality(s) of interest. With respect to soybeans, quality may include, without limitation, oil content, oil profile, fatty acid profile, polyunsaturated fatty acid content, omega-3 content, amino acid profile, flavor, protein content, and whether the grain quality is of food grade or not. These examples of types of grain and types of grain quality related traits are merely representative.

One way of measuring traits is through the use of a near-infrared analyzer. Near-infrared analyzers may be used to indicate grain types or grain constituents as well as other indicators of grain quality. Grain quality can be measured using other types of technologies. For example, grain quality can be determined through imaging the grain and applying appropriate image processing techniques to the image to extract information about the grain.

Another type of technology that can be used for measuring grain quality is the ACURUM system available from DuPont Acurum. The ACURUM system is based on a visual measurement (CCD camera operating in the visible spectral region). This system is currently used for wheat and barley. Examples of grain quality traits include wheat contamination in barley, fungi in wheat, and staining in wheat. Of course, other types of grain quality measurements are contemplated. There are numerous technologies which may yield measures of grain quality such as, but not limited to gas chromatography, acoustical technologies, imaging techniques, and combinations of techniques. The imaging techniques may also include those associated with remote sensing.

These and other technologies can determine numerous types of grain quality traits. For example, NIR or a combination of NIR and UV-visible spectroscopy can report for whole grain and include oil, protein, total starch, extractable starch, fermentability, individual fatty acid levels, and animal feed value in corn. Of course, different types of grains will have different grain quality measurements of interest. In addition, the grain quality measurements of interest may vary depending on the particular end use of the grain, or other factors. Other types of technologies include x-ray diffraction as well as other types of electromagnetic technologies.

Examples of other technologies that can be used for determining crop quality include automated methods of measuring enzymes such as through scalar flow-injection analysis equipment or other types of automated methods or assays.

The grain quality measurements are typically performed at harvest or delivery. The grain quality measurements may be taken using remote sensing techniques and an aerial view of a field prior to harvest. The crop quality measurements may be taken using an appropriately equipped combine or other grain harvesting machine. The grain quality measurements may be taken at any appropriate auger or chute used in the grain handling process associated with harvesting or delivery. As previously explained, the grain quality measurements may also be taken prior to harvest, or can also be taken after delivery. Various types of methods may be used to increase the likelihood that consistent grain quality determinations are made. This can include following of procedures for the calibration of grain quality determination equipment, sampling of grain for additional or independent testing, or other procedures.

The electronic forum 12 also includes a transaction engine 38 which may be used to facilitate transactions between each grower 20 and one or more grain buyers 14, 16, 18. The electronic forum 12 may provide for an online auction so that grain buyers 14, 16, 18 compete for grain from each grower 20. The electronic forum 38 facilitates offerings of grains available for delivery either now or in the future. An auction-method of transacting may be very efficient and accurate in establishing the value of the grain and especially in differentiating the value of grain to end users based on grain quality or predicted grain quality, grain location, grower, and other information.

The electronic forum 12 also allows grain buyers 14, 16, 18, to target one or more specific growers 20. From information available through the electronic forum, or otherwise, a grain buyer may determine that a particular grower has grain of high quality. In such an instance, the grain buyer may make a private bid to the particular grain buyer through the electronic forum 12. The private bid may be at a premium over any public bids. Growers may be alerted of the private bids by sending the private bid notification 41 to a mobile device, by providing a message on the electronic forum 12, or by emailing notification of the private bid to the growers, or otherwise. There may be a deadline associated with each private bid.

In addition, update texting 42 may be communicated from the electronic forum 12 to a mobile device 40 associated with the grower 20. The commodity update texting 42 may include nearby and new crop Chicago Board of Trade (CBOT) futures on selected commodities, and deliver such market information via a text message throughout the day. The frequency of the texting may be set by the grower 20. For example, the text messages may be delivered once a day, twice a day or even five times or more per day. The texting may also include other information of interest to the grower 20 such as grain condition (where grain bins are monitored), upcoming grower meeting notifications, USDA crop report information, or other information of interest. It is contemplated that delivery of this information to a grower 20 may be of particular benefit to the grower 20, as the grower may be out in the field and not able to check a computer to obtain the information. The texting may also allow for a grower to accept an offer for the grower's commodities or otherwise conduct a transaction.

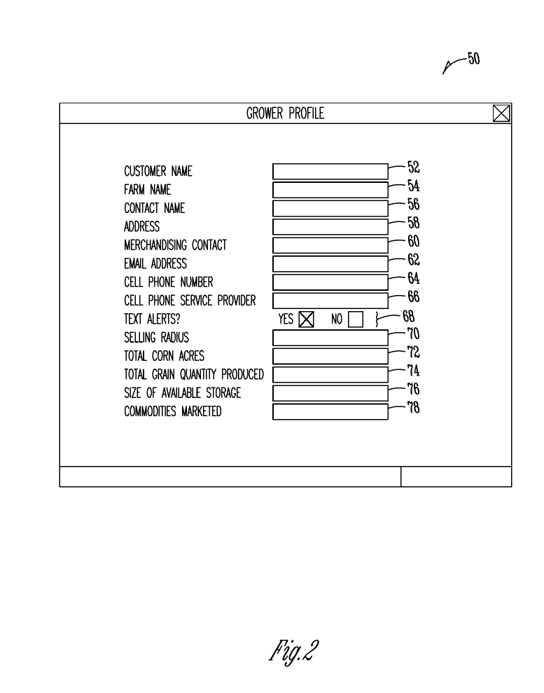

FIG. 2 is an illustration of a screen display associated with a grower profile. It is to be understood that the specific information collected in a grower profile or associated with a grower profile may vary. In the screen display 50 there are various data fields for collecting grower-related information. These fields includes a customer number data field 52, a farm name data field 54, a contact name data field 56, an address data field 58, a merchandising contact data field 60, an email address data field 62, a cell phone number data field 64, a cell phone service provider data field 66, text alerts data field 68 for selecting whether the grower wishes to receive text alerts, a selling radius data field 70, a total corn acres data field 72, a total grain quantity produced data field 74, a size of available storage data field 76, and a commodities marketed data field 78. Although the inputs associated with the data fields are shown as text input boxes or check boxes, the data fields may be of any number of types, including combo boxes, list boxes, drop down list boxes, or other types of inputs. In addition, other information including other information associated with a grower profile may be collected. It is further contemplated that a user need not populate all of the data fields. Some of the data fields may be required, while other of the data fields may be optional. In addition, some of the data fields may be pre-populated with information already available or with default values.

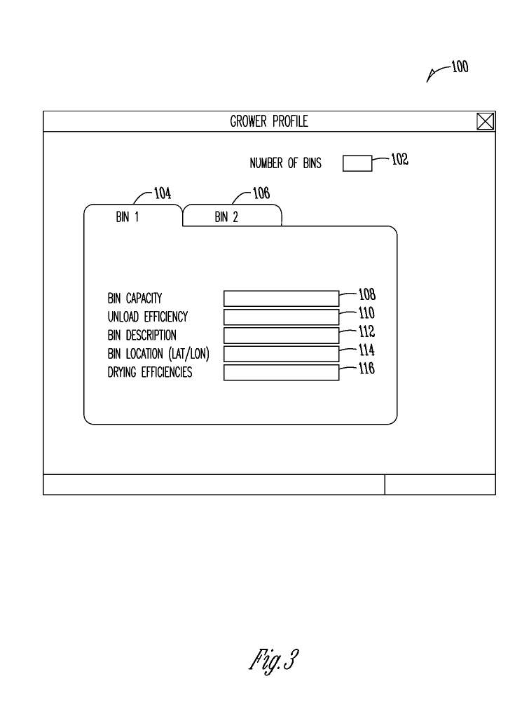

FIG. 3 is an illustration of a screen display associated with a grower profile which provides for capturing information about bins associated with a grower. The screen display 100 allows a grower to indicate the number of bins associated with the grower in the number of bins data field 102. Information may be entered by the grower for each bin, such as using tab 104 for a first bin and tab 106 for a second bin. Data fields used to collect information about each grain bin may include a bin capacity field 109, an unload efficiency field 110, a bin description field 112, a bin location field 114 which may include geo-coordinates such as a latitude and a longitude. Another data field which may be used is a drying efficiency field 116. The drying efficiency field 116 and the unload efficiency field may collect information in suitable units such as bushels per hour.

Information about each bin is helpful in a number of ways. For example, having geo-coordinates for the grain bin allows the system to calculate the distance between the grain bin and a potential market so that delivery time and delivery costs may be considered.

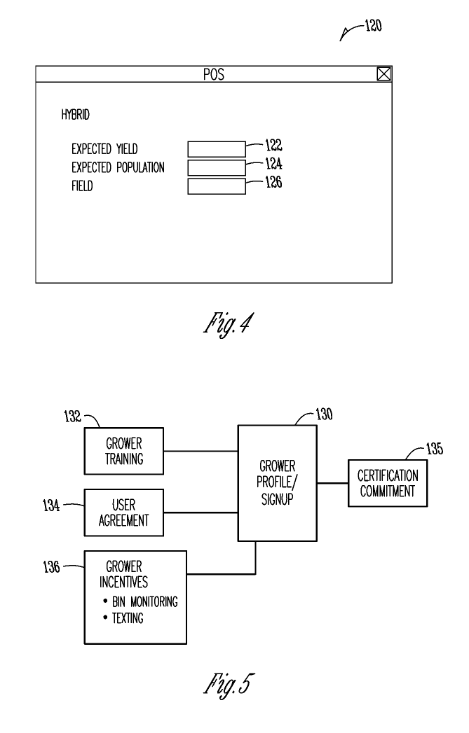

FIG. 4 is an illustration of a screen display associated with a grower profile. The screen display 120 includes an expected yield data field 122, an expected population data field 124, and a field data field 126, all of which may be associated with a particular hybrid or variety. The field data field 126 may include geo-coordinates such as latitude and longitude associated with the field where a particular variety is grown. The information shown in screen display 120 may be entered by a sales agent supplying seed to the grower or may be received from the grower.

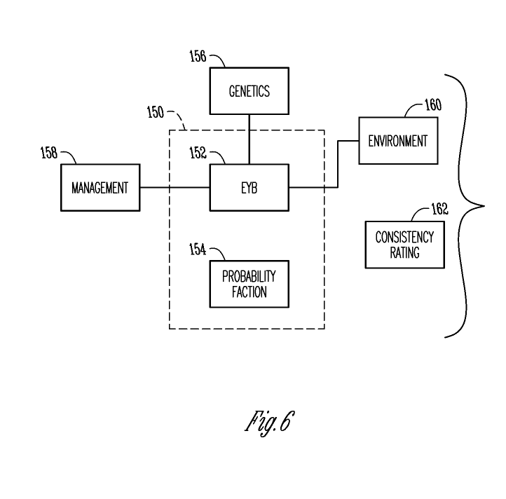

FIG. 5 is a block diagram illustrating additional components which may be associated with a grower profile or grower signup 130. In order to sign up the grower may be required or asked to receive grower training 132. The grower training 132 may be a course, an online course, or other type of training. In addition, the grower may establish themselves as a high quality grower by agreeing to a certification commitment 135 in which they agree to commit to one or more standards associated with high quality grain. A certification commitment for corn growers may include committing to the grower training 132 or otherwise attending a workshop related to principles of quality grain care, passing an examination related to quality grain. The certification commitment may further include agreeing to: use appropriate methods of harvesting to avoid inflated levels of foreign material and broken grain; aspiring to the standard of no more than 1 percent of cracked and broken kernels at the combine during harvest, and 2 percent of cracks and broken kernels during drying and storage; use of quality grain care principles for drying grain, and aspiring to the standards of 130 degrees maximum kernel temperature, and storage moisture of no more than 15 percent; for corn in storage, aspiring to the standard of a maximum grain temperature of 60 degrees; committing to the air flow standard of one horsepower for every 5,000 bushels of stored grain; committing to maintaining a log of incoming wet grain to the dryer, and a corresponding grain storage log; committing to bi-weekly grain condition checks while grain is in storage; committing to covering or shuttering bin fans when they are not in use. Of course, other standards may be used and standards may vary based on type of grain.

Growers, who establish themselves as high quality growers through the certification commitment 135, may be identified as such on the electronic forum so that potential buyers can use such information to assist them in making grain purchase decisions. A particular buyer may elect to only purchase grain from a grower who is certified as a high quality grower. Thus, it may be of benefit to a grower to make the commitment to certification, even if the grower is already producing high quality grain.

The grower may be asked to enter into a user agreement 134 governing the use of the web site or portions thereof. In addition, the grower may be provided with one or more grower incentives 136 for enrolling, signing up, or providing a grower profile 130. Examples of grower incentives include, without limitation, access to free or reduced cost bin monitoring technology, access to a free or reduced cost texting service, or other incentives.

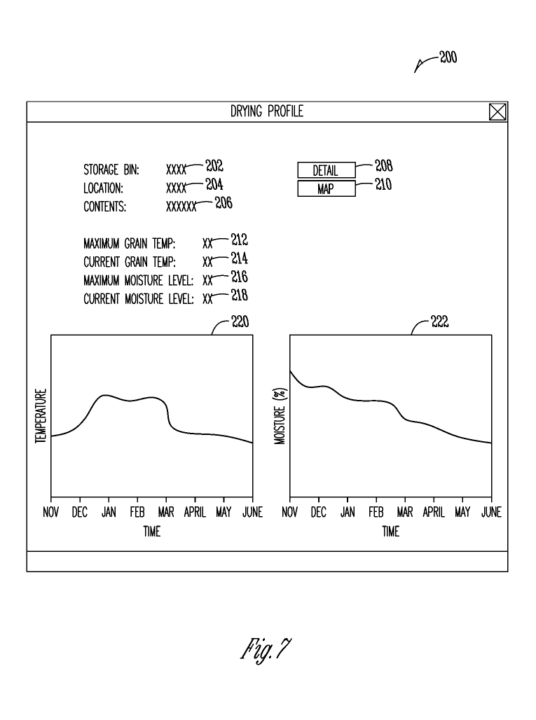

FIG. 6 is a block diagram illustrating how information can be used to assist buyers to determine which crops from which producers are of most interest. Attributes of the grain or a designation of the grain may be provided. The designation may be a product number identifying a plant variety associated with the grain. Examples of quality-related traits for field crops include traits related to ethanol yield, traits related to predicted digestible energy levels, protein content, starch content, extractable starch content, oil content, and extractable oil content. Quality-related traits may include whether or not the crop is of a variety having a particular gene or set of genes. Quality-related traits may be based on amino acid content, fiber content, enzyme content, fatty acid content, oil profile, or other types of content or composition. Quality-related traits may relate to the desired end use. For example, where the crop is used for feed, quality-related traits may include nutrient content, amino acid content, and more specifically, amino acid content of one or more essential dietary amino acids such as arginine, histidine, isoleucine, lysine, methionine, phenylalanine, threonine, tryptophan, and valine.

A consistency rating 162 is shown. The consistency rating 162 provides a measure of feedback for each grower based on their ability to deliver based on their historical performance. This provides information independent from the expected quality parameters of a given hybrid.

A probability factor may also be computed. The probability factor may be associated with a predicted or anticipated quality. For example, for processors who are purchasing grain such as corn for use in ethanol production, the probability factor may be associated with an ethanol yield per bushel (EYB) number which is indicative of quality. The probability factor may represent the relative confidence that a grower will meet the EYB number or another measure of quality. It is contemplated that different end users may be interested in different measures of quality. The probability factor may be adjusted over time in response to consideration of new or changing information. For example, the probability factor may begin with a set level such as a 75 percent confidence based on the particular variety to be grown. As the growing season begins, environmental factors may alter the probability factor. For example, consideration of planting date versus historical planting date may affect the probability factor. The growing degree unit (GDU) progress versus historical GDU progress may affect the probability factor. The monitored soil moisture versus historic soil moisture may affect the probability factor. Any number of other items of environmental data may also affect the probability factor and thus be considered in determining the probability factor.

As environmental data is collected and analyzed, the probability factor may be adjusted if the environmental data affects the relative confidence in the predicted or anticipated EYB number. For example, where the planting date is ahead of schedule, the probability may increase. If the planting date is delayed, the probability factor may stay the same or may decrease. If the growing degree units are ahead of schedule, then the probability factor may increase. If pollination conditions are considered favorable then the probability factor may increase.

Another factor that may be used in determining the probability factor is whether or not the grain is homogenous. Where the grain is homogeneous, the quality of the grain will generally be more consistent and more predictable. This may provide an incentive for growers not to co-mingle grain as it doing so may decrease the value to buyers.

As previously explained, monitoring the drying process assists in determining quality. It is contemplated that such information is used to affect the EYB or the probability factor. For example, a grain condition rating may be used. Where proper drying techniques are used, the grain may have a higher likelihood of meeting a particular quality and therefore be more valuable to a grower. Thus, the EYB, the probability factor, and a grain condition rating may be used to assist in providing a representation of grain quality.

FIG. 7 illustrates one example of a screen display which may be presented to users. Within the window 200, information such as storage bin identifying data 202, storage bin location data 204, storage bin content data 206, or other descriptive data may be provided. As shown in window 200, a detail button 208 may be selected to provide additional information about the storage bin and/or its contents. A map button 210 may be selected to map the location on a map and/or provide other location data.

The drying profile also may include meaningful data regarding the drying process, especially data indicative of grain quality. As previously discussed herein, the drying process used may affect the quality of grain. Therefore, the drying profile may also include a maximum grain temperature 212, a current grain temperature 214, a maximum moisture level 216, and a current moisture level 218. In addition, more detailed temperature and moisture data may be provided. One form such data may take is a graph such as temperature graph 220 which shows the temperature of the grain during the drying process. Another form such data may take is a graph such as moisture graph 222 which shows the moisture level of the grain during the drying process.

The present invention contemplates that the drying profile may be made available in complete detail to the grain producer or seller. The grain producer or seller may determine that some or all of this data may be made available to a potential buyer. Thus, a buyer may be able to better evaluate grain quality prior to entering into a purchase transaction. For example, a buyer may determine that a maximum grain which has had a temperature exceeding 50 degrees Fahrenheit is not suitable for use in a desired end process. Therefore, the buyer will be able to exclude grain which has experienced a higher temperature and potentially value more highly grain which has not exceeded such a temperature. In this manner, the availability of grain quality data creates value for the grain producers as well as the grain buyers or users.

An electronic forum for facilitating transactions for grain using grain quality information has been disclosed. Variations are contemplated in the type of grain, the manner of exchange, the manner in which grain quality is determined, and other variations.

What is claimed:

1. A method for providing an electronic forum for facilitating commercial transactions for grain, comprising:
collecting a grower profile for each of a plurality of growers;
collecting grain bin data for the grain associated with each of the plurality of growers;
determining a representation of grain quality using data comprising grain bin data;
providing to a plurality of buyers access to the representation of grain quality through the electronic forum;
facilitating purchase of the grain from one or more of the plurality of growers by one or more of the plurality of buyers.

2. The method of claim 1 wherein the step of collecting the grain bin data includes electronically monitoring one or more grain bins to collect the grain bin data.

3. The method of claim 2 wherein the step of collecting the grain bin data further includes communicating the grain bin data from the one or more grain bins using a satellite linkage.

4. The method of claim 3 wherein the grain bin data includes grain drying data.

5. The method of claim 4 wherein the grain drying data comprises at least one of temperature data and moisture data.

6. The method of claim 1 further comprising collecting genetic information.

7. The method of claim 6 wherein the data further comprises the genetic information.

8. The method of claim 7 wherein the data further comprises environment data.

9. The method of claim 1 wherein the grain quality includes high total fermentable indicative data.

10. The method of claim 1 further comprising sampling the grain to provide grain sample data.

11. The method of claim 10 wherein the data further comprises grain sample data.

12. The method of claim 10 wherein the sampling the grain being performed at a delivery point for the grain.

13. The method of claim 6 wherein the step of collecting genetic data comprises obtaining sales data and determining the genetic data based on the sales data.

14. The method of claim 1 further comprising feedback data from one or more of the buyers for one or more of the growers.

15. The method of claim 14 further comprising providing access to the feedback data to the plurality of purchasers.

16. The method of claim 1 wherein the step of facilitating purchase of the grain from one or more of the plurality of growers by one or more of the plurality of buyers includes receiving from one of the growers (a) a selection one or more of the plurality of buyers, (b) a number of bushels for sale, (c) a specific ask price, (d) a delivery point, and (e) a delivery period.

17. The method of claim 16 wherein the step of facilitating purchase of the grain from one or more of the plurality of growers by one or more of the plurality of buyers further includes receiving from one of the buyers an acceptance or a counteroffer.

18. The method of claim 1 wherein the grain quality information includes both purity data and composition data.

19. The method of claim 1 further comprising providing on the electronic forum a consistency rating associated with one of the growers and wherein the consistency rating being based on grain quality of prior deliveries of grain.

20. The method of claim 1 wherein the facilitating purchase of the grain being performed through public bids.

21. The method of claim 1 wherein the facilitating purchase of the grain being performed through private bids.

22. A method for providing an electronic forum for facilitating commercial transactions for grain, comprising:
collecting a grower profile for each of a plurality of growers;
collecting grain bin data for the grain associated with each of the plurality of growers;
determining a representation of grain quality based on data comprising the grain bin data;
providing access to a plurality of buyers the representation of the grain quality through the electronic forum;
facilitating purchase of the grain from one or more of the plurality of growers by one or more of the plurality of buyers.

23. The method of claim 22 wherein the collecting of the grain bin data comprises electronically monitoring one or more grain bins to collect the grain bin data.

24. The method of claim 22 wherein the data further includes genetic data affecting the grain quality.

25. The method of claim 22 wherein the data further includes environmental data affecting the grain quality.
